(19) United States
(12) Patent Application Publication
(10) Pub. No.: US 2026/0022751 A1
(43) Pub. Date: Jan. 22, 2026

(54) Electro-Mechanical Brake And Control Method Therefor

(71) Applicant: HYUNDAI MOBIS CO., LTD., Seoul (KR)

(72) Inventor: Dong Hwan LIM, Yongin-si (KR)

(73) Assignee: HYUNDAI MOBIS CO., LTD., Seoul (KR)

(21) Appl. No.: 19/259,422

(22) Filed: Jul. 3, 2025

(30) Foreign Application Priority Data
Jul. 18, 2024 (KR) 10-2024-0095192

(51) Int. Cl. F16D 65/38; B60T 8/171; B60T 8/172; B60T 8/58; B60T 13/74; F16D 66/02; F16D 121/24

(52) U.S. Cl. CPC F16D 65/38; B60T 8/171; B60T 8/172; B60T 8/58; B60T 13/746; F16D 66/026; B60T 2220/04; B60T 2240/00; B60T 2250/00; F16D 2065/386; F16D 2121/24

(57) ABSTRACT

Disclosed are electro-mechanical brake and control method thereof.

According to an embodiment of the present disclosure, there is provided a control method of electro-mechanical brake in which a piston is moved by driving a motor to bring a brake pad into close contact with a wheel disk, the method includes determining whether the vehicle is in a stopped state while traveling by using a wheel speed sensor; in response to a determination that the vehicle is stopped while traveling, determining whether a set brake force command value is included in a preset brake force command interval according to a degree of stroke of a brake pedal; in response to a determination that the brake force command value is included in the preset brake force command interval, determining whether the positions of the piston, the brake pad, and the wheel disk are readjusted; in response to a determination that the positions of the piston, the brake pad, and the wheel disk are not readjusted, determining whether the brake force command value changes within a preset change rate for a preset time; detecting a piston position-based estimated brake force value based on a position detector that detects the position of the piston; in response to a determination that the brake force command value is changed within the preset change rate, determining whether a difference between the brake force command value and the piston position-based estimated brake force value is within a preset value; and in response to a determination that the difference is within the preset value, controlling positions of the piston, the brake pad, and the wheel disk by providing a readjustment command for readjustment of the positions.

### CROSS-REFERENCE TO RELATED APPLICATION

This application claims the benefit of priority to Korean Patent Application No. 10-2024-0095192 filed in the Korean Intellectual Property Office on Jul. 18, 2024 the entire contents of which are incorporated herein by reference.

### TECHNICAL FIELD

The present disclosure relates to an electro-mechanical brake and a control method thereof. More specifically, the present invention relates to an electro-mechanical brake that generates and executes a readjustment command when a vehicle is stopped while traveling, and a control method therefor.

### BACKGROUND

The content described in this section merely provides background information for the present disclosure, but does not constitute the related art.

An electro-mechanical brake (EMB) is a brake apparatus that generates a friction brake force. In the electro-mechanical brake, an actuator driven by a motor is mounted on a brake caliper. The electro-mechanical brake presses the wheel disk using motor, gear box, screw, piston, brake pad, or the like without a medium called brake fluid.

The electro-mechanical brake has a mechanism similar to that of an electronic parking brake (EPB), but since the electro-mechanical brake is a main brake apparatus used during driving, higher reliability, higher durability, and the like are required.

When the driver depresses the pedal, the electro-mechanical brake calculates the required brake force and applies a brake command to each wheel. When the brake command is applied, the motor starts to rotate to advance the piston, and the piston presses the brake pad. The brake pads press the wheel disks so that the brake force is generated.

A conventional electro-mechanical brake (EMB) measures a brake force by using a force sensor and controls the brake force. A force sensor mounted on the electro-mechanical brake is expensive. In addition, the force sensor has the disadvantage of not being able to accurately measure the brake force depending on the mounted position. To overcome these drawbacks, a force sensor-less system is used.

The force sensor-less system is understood to mean the system which estimates the brake force without the use of the force sensor. The electro-mechanical brake to which the force sensor-less system is applied performs calibration. Here, the calibration means the setting the electro-mechanical brake. That is, it refers to the readjusting the positions of the piston, the brake pad, and the wheel disk. The electro-mechanical brake may perform calibration to ascertain the brake force value corresponding to the position of the piston. A map in which brake force values corresponding to the positions of the pistons are indexed is referred to as a force map. By means of the force map, the electro-mechanical brake may determine the brake force without the force sensor and adjust the brake force.

Since a state of the electro-mechanical brake changes according to use, such as wear of the brake pad, it is necessary to update information of the electro-mechanical brake by performing calibration every time the vehicle is used.

That is, the electro-mechanical brake utilizing the force sensor-less system may perform calibration to ascertain the current state of the electro-mechanical brake and generate data for estimating the brake force. It is important that the calibration is terminated in a short time. This is because the driver may travel after the calibration is completed.

Conventional calibration had the issue of being irregular under specific conditions, such as antilock braking system (ABS) operation, sudden braking, or low braking force commands, making calibration unusable.

For example, in winter, the road friction coefficient is lowered due to accumulated snow. Therefore, control is performed in the low brake force command region, and the current waveform becomes irregular due to frequent ABS performance, which makes it difficult to perform calibration. In addition, when driving in the city, since a low deceleration is required, control is performed in a low brake force command region, or actual friction braking usage is reduced due to regenerative braking, so that a current waveform becomes irregular, and it becomes difficult to perform calibration.

### SUMMARY

Disclosed are electro-mechanical brake and control method thereof.

According to an embodiment of the present disclosure, there is provided a control method of electro-mechanical brake in which a piston is moved by driving a motor to bring a brake pad into close contact with a wheel disk, the method includes determining whether the vehicle is in a stopped state while traveling by using a wheel speed sensor; when the vehicle is stopped while traveling, determining whether a set brake force command value is included in a preset brake force command interval according to a degree of stroke of a brake pedal; when the brake force command value is included in the preset brake force command interval, determining whether the positions of the piston, the brake pad, and the wheel disk are readjusted; when the positions of the piston, the brake pad, and the wheel disk are not readjusted, determining whether the brake force command value changes within a preset change rate for a preset time; detecting a piston position-based estimated brake force value based on a position detection unit that detects the position of the piston; when the brake force command value is changed within the preset change rate, determining whether a difference between the brake force command value and the piston position-based estimated brake force value is within a preset value; and when the difference is within the preset value, generating a readjustment command for readjusting positions of the piston, the brake pad, and the wheel disk.

A main object of an electro-mechanical brake and a control method thereof according to an embodiment is to accurately provide a brake force by detecting a change in a characteristic of a brake pad when a vehicle stop state or an automatic brake holding function is performed during traveling.

An electro-mechanical brake and a control method thereof according to an embodiment have a main purpose of reducing a sense of heterogeneity and noise felt by a driver by preventing a sudden change in the brake force when a calibration is performed while driving.

The problems to be solved by the present invention are not limited to the above-mentioned problems, and other problems that are not mentioned will be clearly understood by those skilled in the art from the following description.

According to an embodiment of the present disclosure, there is provided a control method of electro-mechanical brake in which a piston is moved by driving a motor to bring a brake pad into close contact with a wheel disk, the method includes determining whether the vehicle is in a stopped state while traveling by using a wheel speed sensor; when the vehicle is stopped while traveling, determining whether a set brake force command value is included in a preset brake force command interval according to a degree of stroke of a brake pedal; when the brake force command value is included in the preset brake force command interval, determining whether the positions of the piston, the brake pad, and the wheel disk are readjusted; when the positions of the piston, the brake pad, and the wheel disk are not readjusted, determining whether the brake force command value changes within a preset change rate for a preset time; detecting a piston position-based estimated brake force value based on a position detection unit that detects the position of the piston; when the brake force command value is changed within the preset change rate, determining whether a difference between the brake force command value and the piston position-based estimated brake force value is within a preset value; and when the difference is within the preset value, generating a readjustment command for readjusting positions of the piston, the brake pad, and the wheel disk.

According to an exemplary embodiment, the electro-mechanical brake and the control method of the electro-mechanical brake have an effect of accurately providing the brake force by detecting a change in the characteristic of the brake pad when the vehicle is in stopped state or the automatic brake holding function is performed while traveling.

According to an embodiment, the electro-mechanical brake and the control method therefor have an effect of preventing a sudden brake force change and reducing a sense of heterogeneity and noise felt by the driver when a readjustment command is performed during traveling.

### BRIEF DESCRIPTION OF THE DRAWINGS

FIG. 1 is a block diagram illustrating a configuration of the electro-mechanical brake according to an embodiment of the present disclosure.

FIG. 2 is a diagram illustrating a configuration of the brake force generating unit according to an embodiment of the present disclosure.

FIG. 3A is a flowchart illustrating control method of the electro-mechanical brake according to an embodiment of the present disclosure.

FIG. 3B is a graph illustrating a generation and execution interval of the readjustment command according to an embodiment of the present disclosure.

FIG. 4A is a flowchart illustrating step S320 of FIG. 3A of the present disclosure.

FIG. 4B is a graph illustrating the apply interval and hold interval according to an embodiment of the present disclosure.

FIG. 5 is a flowchart illustrating step S340 of FIG. 3A of the present disclosure.

FIG. 6 is a flowchart illustrating step S360 of FIG. 3A of the present disclosure.

FIG. 7 is a flowchart illustrating control method of the electro-mechanical brake when the readjustment command of the present disclosure is executed.

FIG. 8A is a flowchart illustrating step S790 of FIG. 7 of the present disclosure.

FIG. 8B is a flowchart illustrating another embodiment of FIG. 8A of the present disclosure.

FIG. 9 is a graph illustrating the readjustment command and the delay flag interval according to another embodiment of the present disclosure.

### DETAILED DESCRIPTION

Hereinafter, some embodiments of the present disclosure will be described in detail with reference to exemplary drawings. Note that when components in each drawing are denoted by reference numerals, the same components are denoted by the same numerals as much as possible even if they are denoted on different drawings. In addition, in describing the present disclosure, if it is determined that a specific description of a related known configuration or function may obscure the gist of the present disclosure, the detailed description thereof will be omitted.

In describing components of embodiments of the present disclosure, reference numerals such as first, second, i), ii), a), and b) may be used. These symbols are only used to distinguish the components from other components, and the nature, sequence, order, or the like of that component is not limited by the symbols. Throughout the specification, when it is stated that a certain portion “includes” or “comprises” a specific component, it shall be understood that, unless explicitly otherwise specified, this does not exclude other components but may further include additional components.

In describing the components of the present invention, the terms “first,” “second,” “A,” “B,” “(a),” “(b),” and the like may be used. These terms are only used to distinguish the components from other components, and the nature, sequence, order, or the like of the components is not limited by these terms.

When any component is described as being “connected,” “coupled,” or “linked” to another component, it should be understood that the component may be directly connected or linked to the other element, but another component may also be “connected,” “coupled,” or “linked” between each component.

The terms “unit,” “module” and the like described in the specification mean a unit that processes at least one function or operation, and may be implemented by hardware or software, or a combination of hardware and software.

Unless otherwise specified, it should be understood that the description of one embodiment may be applied to other embodiments.

The description set forth below in connection with the appended drawings is intended to describe exemplary embodiments of the invention and is not intended to represent the only embodiments in which the invention may be practiced.

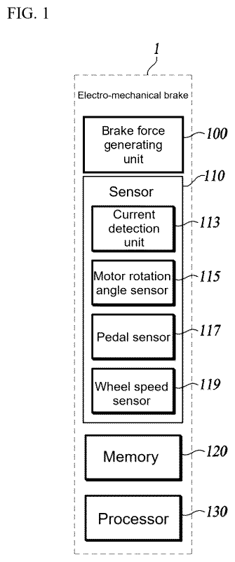

FIG. 1 is a block diagram illustrating a configuration of the electro-mechanical brake according to an embodiment of the present disclosure.

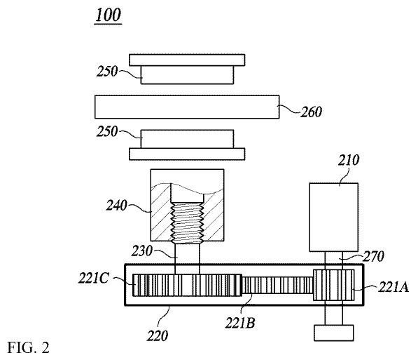

FIG. 2 is a diagram illustrating a configuration of the brake force generating unit according to an embodiment of the present disclosure.

Referring to FIGS. 1 and 2, the electro-mechanical brake (EMB) 1 may include all or a part of the brake force generating unit 100, the sensor 110, the memory 120, and processor 130. The electro-mechanical brake 1 generates a friction brake force. The electro-mechanical brake 1 does not use hydraulic pressure, resulting in a faster response speed and being more environmentally friendly compared to a hydraulic brake (not shown). The electro-mechanical brake 1 is capable of independently controlling each wheel (not shown), thereby enhancing braking stability.

When the driver depresses a brake pedal (not shown), the brake force generating unit 100 calculates a necessary brake force based on a stroke amount of the driver, and then generates the brake force. The brake force generating unit 100 may be mounted on the wheel of the vehicle to generate the brake force. The brake force generating unit 100 may be mounted on each wheel of the vehicle. The brake force generating unit 100 may independently generate and independently control the brake force for each wheel. The brake force generating unit 100 brakes the vehicle by changing the kinetic energy of the vehicle in the form of thermal energy using the frictional force.

The brake force generating unit 100 may include all or a part of motor 210, gear box 220, power transfer 230, piston 240, brake pad 250, rotation shaft 270, and wheel disk 260. The brake force generating unit 100 is not limited by the disclosure of the drawings.

For example, the shape, size, arrangement, and the like of the motor 210, the gear box 220, the power transfer 230, the piston 240, the brake pad 250, the rotation shaft 270, and the wheel disk 260 are not limited by the disclosure of the drawings.

The motor 210 rotates to move the piston 240. As used herein, the direction of the piston 240 is defined. The forward movement means the case where the piston 240 moves toward the wheel disk 260. The backward movement means the case where the piston 240 moves in the opposite direction to the wheel disk 260.

According to an embodiment, the motor 210 may be DC motor, AC motor, induction motor, synchronous motor, step motor, servo motor, Brushless Direct Current (BLDC) motor, linear motor, Permanent Magnet Synchronous Motor (PMSM), or the like.

One side of the gear box 220 is connected to the motor 210, and the other side of the gear box 220 is connected to the power transfer 230. The gear box 220 is configured to transfer power of the motor 210 to the power transfer 230. The gear box 220 includes a plurality of gears 221 therein. The gear box 220 may boost the rotational force by meshing and rotating the plurality of gears 221. The shape and arrangement of the gear box 220 are not limited by the drawings. Each of the plurality of gears 221 is not limited to the shape and number disclosed in the drawings.

The power transfer 230 may receive power from the gear box 220. The power transfer 230 may provide power to the piston 240.

According to an embodiment, the power transfer 230 may be a screw shaft. In this case, the piston 240 may be screw coupled to the screw shaft. When the screw shaft rotates, the screw connection may be connected or disconnected. Further, when the screw shaft rotates, the piston 240 may move forward or backward.

The piston 240 receives power from the power transfer 230 and moves. When piston 240 moves forward, piston 240 presses on brake pad 250. The brake pad 250 presses the rotating wheel disk 260 to brake the vehicle.

The brake pads 250 may be a pair. A pair of brake pads 250 may be disposed on either side of the wheel disk 260. The wheel disk 260 is coupled to and rotates with the wheels of the vehicle. When the piston 240 presses the brake pad 250, the brake pad 250 may press the wheel disk 260. When the brake pad 250 presses the wheel disk 260, the brake pad 250 is compressed and a brake force is generated. As the distance that the piston 240 moves forward increases, the brake force increases because the force with which the brake pad 250 presses the wheel disk 260 increases.

The sensor 110 may include current detection unit 113, motor rotation angle sensor 115, pedal sensor 117, wheel speed sensor 119, and the like.

According to an embodiment, the current detection unit 113 may detect a current flowing through the motor 210. For example, a current sensor (not shown) may be included to detect a current flowing through the motor 210. The electro-mechanical brake 1 may control a current flowing through the motor 210 by using the current detection unit 113.

According to an embodiment, the motor rotation angle sensor 115 may detect a rotation angle of the motor 210. The rotation of the motor 210 causes the piston 240 to move forward or backward. That is, since the position of the piston 240 is determined by the rotation angle of the motor 210, the electro-mechanical brake 1 may detect the position of the piston 240 using the motor rotation angle sensor 115.

According to an embodiment, the pedal sensor 117 generates the brake pedal signal according to the stroke amount of the brake pedal (not shown). The electro-mechanical brake 1 may calculate a brake force to be generated based on a signal from the pedal sensor 117.

According to an embodiment, the wheel speed sensor 119 measures the wheel speed of the wheel of the vehicle. The wheel speed sensor 119 may transmit the measured wheel speed to processor 130. The processor 130 may determine whether the vehicle is traveling using the wheel speed sensor 119.

A force map may be stored in the memory 120. The map in which brake force values corresponding to the position of the piston 240 are indexed is referred to as the force map. A force sensor-less system refers to the system that estimates the brake force without using the force sensor.

The electro-mechanical brake 1 according to the present disclosure may determine the brake force and adjust the brake force by the force map even without a force sensor. This is because the position of the piston 240 is known by the motor rotation angle sensor 115, and the brake force corresponding to the position of the piston 240 is known by the force map.

Specifically, the position of the piston 240 at a time point at which the brake pad 250 and the wheel disk 260 come into contact with each other and the brake force starts to be generated may be defined as a contact point, and the brake force may be calculated by using a distance between the contact point and the piston 240.

The greater the distance the piston 240 has moved forward from the contact point, the greater the brake force. That is, when the motor rotation angle sensor 115 detects the current rotation angle of the motor 210, the current position of the piston 240 may be known, and the current brake force by the electro-mechanical brake 1 may be known even without the force sensor. Since the force sensor is expensive, there is a cost reduction effect in the case of the force sensor-less system.

The processor 130 may generate the readjustment command for readjusting the positions of the piston 240, the brake pad 250, and the wheel disk 260, and control to execute the readjustment instruction.

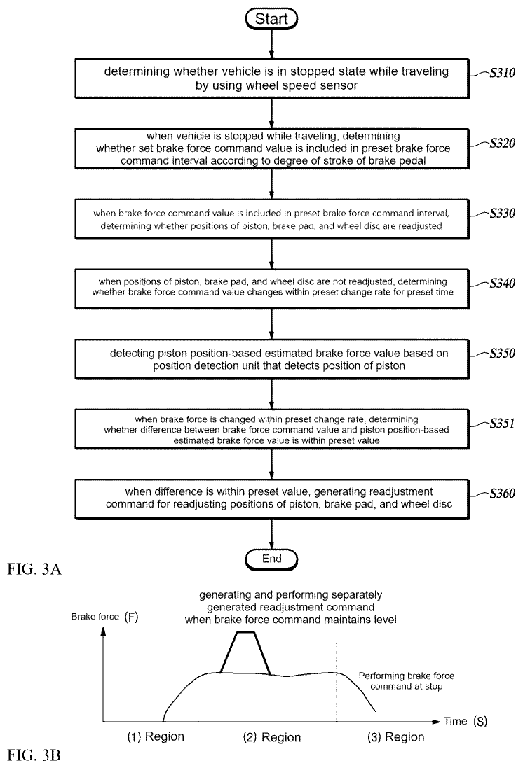

FIG. 3A is a flowchart illustrating control method of the electro-mechanical brake according to an embodiment of the present disclosure.

FIG. 3B is a graph illustrating a generation and execution interval of the readjustment command according to an embodiment of the present disclosure.

Referring to FIG. 3A, a process in which the processor 130 generates the readjustment command for readjusting the positions of the piston 240, the brake pad 250, and the wheel disk 260 is illustrated.

The processor 130 may determine whether the vehicle is stopped while traveling by using the wheel speed sensor 119 (S310). Here, the stop state during traveling means a temporary stop state such as stopping to wait for the signal while traveling. The processor 130 may collect the signal from the wheel speed sensor 119 in real time, and analyze the frequency of the collected signal to calculate the rotational speed of the current wheel.

The processor 130 may check whether the calculated rotational speed is less than a set threshold, and check whether the speed less than the threshold lasts for a certain period of time or more. The processor 130 determines that the vehicle is in a stopped state when the rotation speed is less than a threshold value and the speed less than the threshold value lasts for a certain period of time or more.

When the vehicle is in the stopped state, the processor 130 may determine whether the set brake force command value is included in the preset brake force command interval according to the degree of stroke of the brake pedal (not shown) (S320).

Referring to FIG. 3B, it is shown in which interval the readjustment command is generated and executed as the brake force command value changes while the vehicle is traveling. The first region indicates interval in which the brake force command is generated. This is interval in which the driver presses the brake pedal (not shown) to generate the brake force. The first region is interval in which the brake force command value is increased, but the readjustment command is not generated.

The second region indicates interval in which the driver maintains the stroke force of the brake pedal (not shown) to maintain the brake force. This is interval in which the brake force command value reaches a certain level and is maintained, and the readjustment command is generated and executed in this interval.

The third region indicates interval for resetting the brake force command. Resetting the brake force command means returning the brake force command to the initial state. The driver may release the brake pedal (not shown) to release the brake force. The brake force command value is reduced, and the readjustment command is also reset.

In the third region, the driver may press the brake pedal (not shown) to increase the brake force. Even if the brake force command value increases due to an increase in the brake force, the readjustment command is reset. However, it is not necessarily limited to the above embodiment.

That is, the readjustment command may be generated and executed only in the second region in which the driver maintains the stroke force of the brake pedal (not shown) after the vehicle stops.

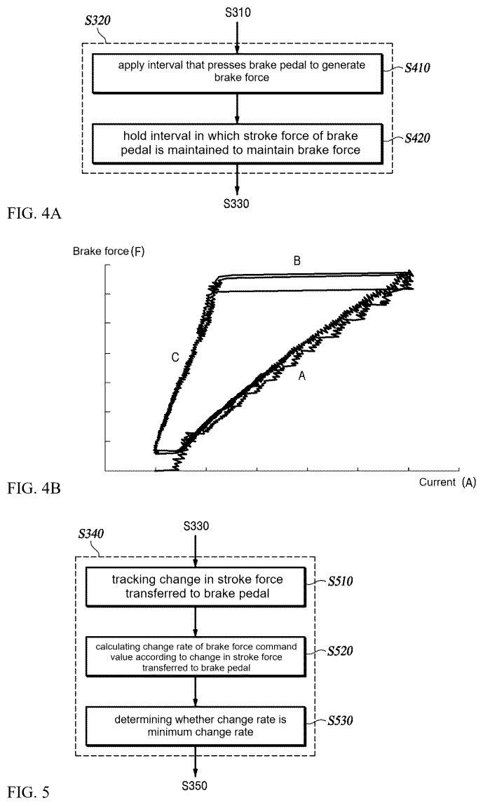

FIG. 4A is a flowchart illustrating step S320 of FIG. 3A of the present disclosure.

FIG. 4B is a graph illustrating the apply interval and hold interval according to an embodiment of the present disclosure.

Referring to FIGS. 4A and 4B, the preset brake force command interval may include the apply interval and the hold interval. The application interval is interval in which the brake pedal (not shown) is pressed to generate the brake force (S410). In the apply interval, the brake force command value according to the current gradually increases due to the ball screw efficiency. The apply interval means the region A in FIG. 4B.

On the other hand, the release interval is interval in which the brake pedal (not shown) is released to release the brake force. In the release interval, the brake force command value rapidly decreases with the current due to the ball screw efficiency. Therefore, the current is irregular, and the readjustment command may not be executed. Therefore, the release interval is not included in the preset brake force command period. The release zone means region C in FIG. 4B.

The hold interval is interval in which the stroke force of the brake pedal (not shown) is maintained to maintain the brake force (S420). In the hold interval, the brake force command value in accordance with the current is kept constant. The hold period means the region B in FIG. 4B.

When the brake force command value is included in the preset brake force command interval, the processor 130 may determine whether the positions of the piston 240, the brake pad 250, and the wheel disk 260 have been readjusted. When the processor 130 has already performed readjustment, the processor 130 determines whether to perform re-adjustment to prevent unnecessary re-execution.

When the positions of the piston 240, the brake pad 250, and the wheel disk 260 are not readjusted, the processor 130 may determine whether the brake force command value is changed within a preset change rate for the preset time (S340).

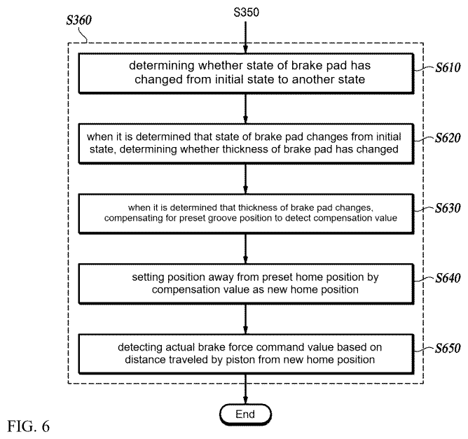

FIG. 5 is a flowchart illustrating step S340 of FIG. 3A of the present disclosure.

Referring to FIG. 5, in order to determine whether the processor 130 is changed within a preset change rate, the processor 130 tracks a change in the stroke force transmitted to the brake pedal (not shown) (S510). The processor 130 calculates a change rate of the brake force command value according to a change in the stroke force transmitted to the brake pedal (not shown) (S520). The processor 130 determines whether the change rate is the minimum change rate (S530). The preset change rate is a minimum change rate.

For example, the preset rate of change may be limited to within about + or −1,000 N/s (about 3 bar/s). However, 1,000 N/s is a value derived from a system response perspective, and may vary depending on the system. Therefore, the present invention is not necessarily limited to the above embodiments.

The processor 130 may detect the piston position-based estimated brake force value based on the position detection unit that detects the position of the piston 240 (S350). The position detection unit may be referred to as a position detector. The position detector may include the motor rotation angle sensor 115. The processor 130 may detect the position of the piston 240 using a position detection unit including the motor rotation angle sensor 115.

The processor 130 may determine whether the difference between the brake force command value and the piston position-based estimated brake force value is within a preset value when the brake force instruction value is changed within a preset change rate for a preset time (S351). The difference between the brake force command value and the piston-position-based estimated brake force value may be within 200 N.

For example, if the difference between the brake force command value and the piston position-based estimated brake force value deviates from a predetermined value even if the change rate is within (+) or (−) 1,000 N/s, the current rapidly increases due to a sudden error when the readjustment command is executed. Therefore, it is possible to stably execute the readjustment command when the difference between the brake force command value and the piston position-based estimated brake force value is within 200 N. However, the present invention is not necessarily limited to the above embodiments.

When the difference between the brake force command value and the piston position-based estimated brake force value is within a predetermined value, the processor 130 may generate a readjustment command for readjusting the positions of the piston 240, the brake pad 250, and the wheel disk 260 (S360).

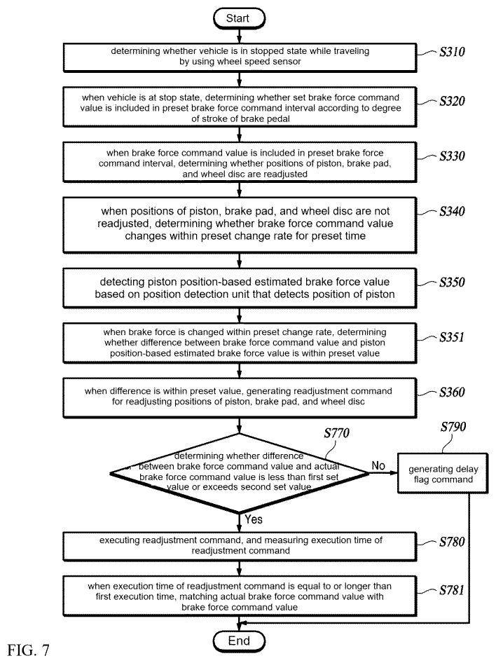

FIG. 6 is a flowchart illustrating step S360 of FIG. 3A of the present disclosure.

Referring to FIG. 6, the processor 130 may determine whether the state of the brake pad 250 has changed from the initial state to another state (S610). When the processor 130 determines that the state of the brake pad 250 has changed from the initial state to another state, the processor 130 determines whether the thickness of the brake pad 350 has changed (S620).

When the processor 130 determines that the thickness of the brake pad 250 has changed, the processor 130 detects a compensation value by compensating for the preset home position (S630). The compensation value means a thickness change value of the brake pad 250. A home position is understood to mean the position at which the piston 240 is arranged during non-braking. That is, the piston 240 pressing the brake pad 250 during braking returns to the home position during non-braking.

The processor 130 sets a position separated from the preset home position by the compensation value as the new home position (S640). The processor 130 may detect the actual brake force command value based on the distance traveled by the piston 240 from the new home position (S650).

Readjusting the positions of the piston 240, the brake pad 250, and the wheel disk 260 is referred to as calibration. The electro-mechanical brake may readjust the positions of the piston 240, the brake pad 250, and the wheel disk 260 to obtain an actual brake force command value corresponding to the position of the piston 240. A map in which brake force values corresponding to the position of the piston 240 are indexed is referred to as a force map. By means of the force map, the electro-mechanical brake may ascertain the brake force without a force sensor and adjust the brake force.

The state of the electro-mechanical brake changes with use, such as wear of the brake pad 250, so that the positions of the piston 240, the brake pad 250 and the wheel disk 260 may be readjusted each time the vehicle is used.

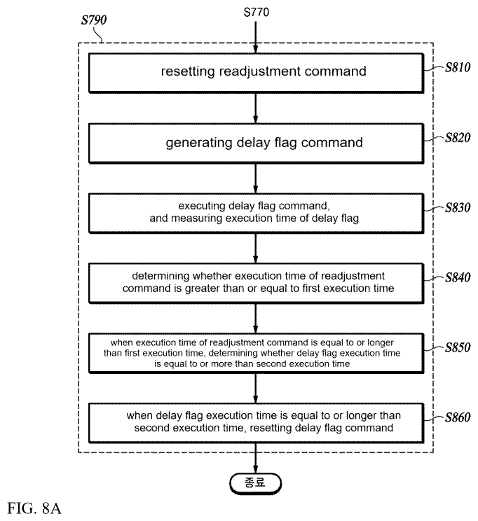

FIG. 7 is a flowchart illustrating control method of the electro-mechanical brake when the readjustment command of the present disclosure is executed. Here, the description overlapping with the method for controlling the electro-mechanical brake according to the embodiment of FIG. 3A will be omitted.

Referring to FIG. 7, the processor 130 may further include a process of determining whether a difference between the brake force command value and the actual brake force command values is less than a first set value or exceeds a second set value in order to execute and complete the readjustment command (S770).

When the driver presses the brake pedal (not shown), the processor 130 may determine whether a difference between the brake force command value and the actual brake force command value is less than a first set value.

For example, when the brake pedal (not shown) is pressed to increase the brake force command value due to the driver's braking intention, if the difference between the actual brake force command values and the increased brake force commands is 600 N or more, the second region needs to enter the third region. This is because when the brake force command value increases, the current rapidly changes and the readjustment command cannot be executed. The first set value being set to 600 N may vary depending on the characteristics of the system. That is, the present invention is not necessarily limited to the above embodiments.

When the driver releases the brake pedal (not shown), the processor 130 may determine whether a difference between the brake force command value and the actual brake force command values exceeds a second set value.

For example, in a case where the brake pedal (not shown) is released due to the driver's braking intention and the brake force command value is decreased, when the difference between the actual brake force command value and the decreased brake force command value is less than or equal to −300 N, it is necessary to enter the third region from the second region. This is because when the brake force command value decreases, the current rapidly changes and the readjustment command cannot be executed. The second set value being set to (−) 300 N may vary depending on the characteristics of the system. That is, the present invention is not necessarily limited to the above embodiments.

The processor 130 may further include a process of executing a readjustment command and measuring an execution time of the readjustment command when the processor 130 determines that a difference between the brake force command value and the actual brake force command value is less than the first set value or exceeds the second set value (S780).

When the execution time of the readjustment command is equal to or longer than the first execution time, the processor 130 may match the actual brake force command value with the brake force command values (S781). That is, the brake force may be controlled by the brake force command value after the readjustment command is completed.

The first execution time may be defined as a value obtained by dividing the target brake force value by the readjustment command by a target brake force change rate. The target brake force value set by the readjustment command means the actual brake force command value. That is, the first execution time means a time taken for the readjustment command to reach the actual brake force command value.

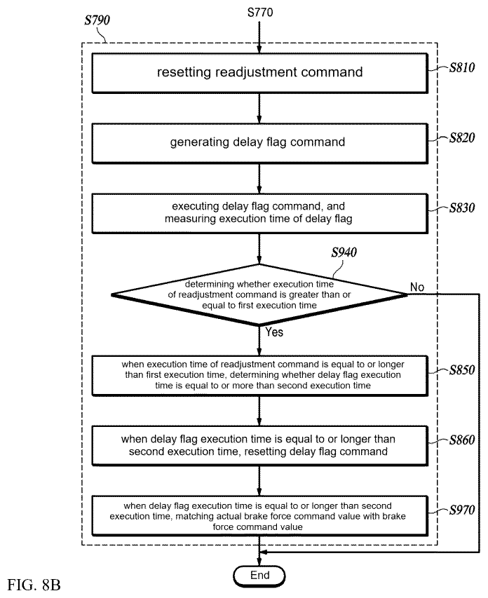

FIG. 8A is a flowchart illustrating step S790 of FIG. 7 of the present disclosure. The description of the method for controlling the electro-mechanical brake according to the embodiment of FIGS. 3A and 7 will not be repeated.

Referring to FIG. 8A, when the processor 130 determines that the difference between the brake force command value and the actual brake force command values is greater than or equal to the first set value or less than or equal to a second set value, the processor 130 may generate a latency flag command.

The delay state flag command is a state flag that is set to prevent a sudden brake force change and induce a gradual brake force change while the readjustment command is executed, so as to minimize the sense of heterogeneity and noise felt by the driver.

When the processor 130 determines that the difference between the brake force command value and the actual brake force command values is equal to or greater than the first set value or equal to or less than the second set value, the processor 130 may reset the readjustment command (S810).

The processor 130 may generate a delay flag instruction (S820). The processor 130 may execute the delay flag instruction and measure the execution time of the delay flag (S830).

The processor 130 may determine whether the execution time of the readjustment instruction is equal to or longer than the first execution time (S840). When the processor 130 determines that the execution time of the readjustment instruction is equal to or longer than the first execution time, the processor 130 may determine whether the execution time of a delay state flag is equal to or greater than the second execution time (S850).

The second execution time may be defined as a value obtained by dividing the brake force command value by the brake force change rate at the time of release from the target brake force value by the readjustment command. The target brake force value set by the readjustment command means the actual brake force command value.

However, when the driver's braking intention changes rapidly, the delay flag command should be ignored and the actual brake force value should be matched with the brake force command value as quickly as possible. This is to immediately cope with an emergency rather than a sense of heterogeneity due to noise in an emergency.

When the processor 130 determines that the delay flag execution time is equal to or longer than the second execution time, the processor 130 may reset the delay flag instruction (S860).

FIG. 8B is a flowchart illustrating another embodiment of FIG. 8A of the present disclosure.

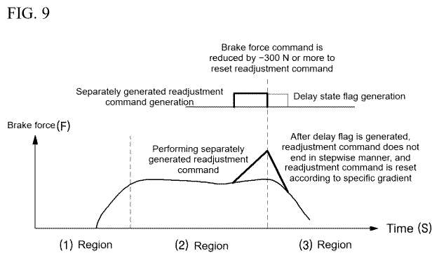

FIG. 9 is a graph illustrating the readjustment command and the delay flag interval according to another embodiment of the present disclosure. The description of the method for controlling the electro-mechanical brake according to the embodiment of FIGS. 3A and 7 will not be repeated.

Referring to FIGS. 8B and 9, the processor 130 may determine whether the execution time of the readjustment instruction is equal to or longer than the first execution time (S940).

However, when the processor 130 determines that the execution time of the readjustment instruction is less than or equal to the first execution time, the processor 130 may reset the readjustment command and the delay flag command. That is, the processor 130 may reset the readjust instruction and the delay flag instruction when the readjust instruction is not sufficiently executed.

When the processor 130 determines that the execution time of the delay flag is equal to or longer than the second execution time, the processor 130 may match the actual brake force command value with the brake force command values (S970). That is, the brake force may be controlled by the brake force command after the readjustment command and the delay flag command are completed.

Each component of the apparatus or method according to the present disclosure may be implemented by hardware or software, or may be implemented by a combination of hardware and software. In addition, a function of each component may be implemented in software, and a microprocessor may be implemented to execute a function of the software corresponding to each component.

Various implementations of the systems and techniques described herein may be realized in digital electronic circuitry, integrated circuitry, field programmable gate arrays (FPGAs), application specific integrated circuits (ASICs), computer hardware, firmware, software, and/or combinations thereof. These various implementations may include implementation in one or more computer programs that are executable on a programmable system. The programmable system includes at least one programmable processor (which may be a special-purpose processor or a general-purpose processor) coupled to receive data and commands from, and to transmit data and commands to, storage systems, at least one input device, and at least one output device. Computer programs (also known as programs, software, software applications, or code) include commands for a programmable processor and are stored in a “computer readable recording medium”.

The computer-readable recording medium includes all kinds of recording devices in which data that may be read by a computer system is stored. The computer-readable recording medium may be a non-volatile or non-transitory medium such as ROM, CD-ROM, magnetic tape, floppy disc, memory card, hard disc, magneto-optical disc, or storage device, and may further include transitory medium such as data transmission medium. In addition, the computer-readable recording medium may be distributed in a network-connected computer system, and the computer-readable code may be stored and executed in a distributed manner.

In the flowcharts/timing diagrams of the present specification, each process is described as being executed sequentially, however, this is merely an example of the technical idea of an embodiment of the present disclosure. In other words, the flowcharts/timing diagrams are not limited to a chronological order, as those skilled in the art may make various modifications and variations to the sequence of the flowchart/timing diagram or to perform one or more of the processes in parallel without departing from the essential characteristics of the embodiments of the present disclosure.

The foregoing descriptions are merely illustrative of the technical idea of the present embodiment, and various modifications and variations may be made by those skilled in the art without departing from the essential characteristics of the present embodiment. Therefore, the present embodiments are not intended to limit the technical idea of the present embodiments, but are intended to be illustrative, and the scope of the technical idea of this embodiment is not limited by these embodiments. The protection scope of the present embodiment is to be construed according to the following claims, and all technical ideas within the scope equivalent thereto are construed as being included in the scope of rights of the present embodiment.

1. A control method of electro-mechanical brake in which a piston is moved by driving a motor to bring a brake pad into close contact with a wheel disk, the method comprising:
determining whether the vehicle is in a stopped state while traveling by using a wheel speed sensor;
in response to a determination that the vehicle is stopped while traveling, determining whether a set brake force command value is included in a preset brake force command interval according to a degree of stroke of a brake pedal;
in response to a determination that the brake force command value is included in the preset brake force command interval, determining whether the positions of the piston, the brake pad, and the wheel disk are readjusted;
in response to a determination that the positions of the piston, the brake pad, and the wheel disk are not readjusted, determining whether the brake force command value changes within a preset change rate for a preset time;
detecting a piston position-based estimated brake force value based on a position detector that detects the position of the piston;
in response to a determination that the brake force command value is changed within the preset change rate, determining whether a difference between the brake force command value and the piston position-based estimated brake force value is within a preset value; and
in response to a determination that the difference is within the preset value, controlling positions of the piston, the brake pad, and the wheel disk by providing a readjustment command for readjustment of the positions.

2. The control method of electro-mechanical brake of claim 1, wherein:
controlling positions of the piston, the brake pad, and the wheel disk comprises:
determining whether a state of the brake pad has changed from an initial state to another state;
in response to a determination that the state of the brake pad changes from the initial state to another state, determining whether the thickness of the brake pad has changed;
in response to a determination that the thickness of the brake pad changes, compensating for a preset groove position to detect a compensation value;
setting a position away from the preset home position by the compensation value as a new home position; and
detecting an actual brake force command value based on a distance traveled by the piston from the new home position.

3. The control method of electro-mechanical brake of claim 2, wherein:
the preset brake force command interval comprises:
an apply interval that presses the brake pedal to generate the brake force; and
a hold interval in which the stroke force of the brake pedal is maintained to maintain the brake force.

4. The control method of electro-mechanical brake of claim 2, wherein:
determining whether the brake force command value changes within the preset change rate for the preset time comprises:
tracking a change in a stroke force transferred to the brake pedal;
calculating a change rate of the brake force command value according to the change in the stroke force transferred to the brake pedal; and
determining whether the change rate is a minimum change rate.

5. The control method of electro-mechanical brake of claim 1, wherein:
a difference between the brake force command value and the piston position-based estimated brake force value is 200 N or less.

6. The control method of electro-mechanical brake of claim 2, wherein:
controlling positions of the piston, the brake pad, and the wheel disk further comprises:
determining whether a difference between the brake force command value and the actual brake force command value is less than a first set value when the brake pedal is pressed or whether the difference between the brake force command value and the actual brake force command value exceeds a second set value when the brake pedal is released.

7. The control method of electro-mechanical brake of claim 6, further comprising:
in response to a determination that the difference between the brake force command value and the actual brake force command value is less than the first set value when the brake pedal is pressed or the difference between the brake force command value and the actual brake force command value is greater than the second set value when the brake pedal is released, executing the readjustment command and measuring an execution time of the readjustment command;
wherein when the execution time of the readjustment command is equal to or longer than a first execution time, matching the actual brake force command value and the brake force command values.

8. The control method of electro-mechanical brake of claim 6, comprising:
in response to a determination that the difference between the brake force command value and the actual brake force command value is equal to or greater than the first set value when the brake pedal is pressed, or the difference between the brake force command value and the actual brake force command value is equal to or less than the second set value when the brake pedal is pressed,
resetting the readjustment command;
generating a delay flag command;
executing the delay flag command, and measuring the execution time of the delay flag;
determining whether an execution time of the readjustment command is greater than or equal to a first execution time;
in response to a determination that the execution time of the readjustment command is equal to or longer than the first execution time, determining whether the delay flag execution time is equal to or more than a second execution time; and
in response to a determination that the delay flag execution time is equal to or longer than the second execution time, resetting the delay flag command.

9. The control method of electro-mechanical brake of claim 8, wherein:
in response to a determination that the delay flag execution time is equal to or longer than the second execution time, matching the actual brake force command value to the brake force command values.

10. The control method of electro-mechanical brake of claim 8, further comprising:
in response to a determination that the execution time of the readjustment command is equal to or less than the first execution time,
resetting the readjustment command and the delay flag command.
